(19) United States
(12) Patent Application Publication
(10) Pub. No.: US 2019/0123433 A1
(43) Pub. Date: Apr. 25, 2019

(54) BEAMFORMING FOR WIRELESS VEHICLE COMMUNICATION

(71) Applicant: Ford Global Technologies, LLC, Dearborn, MI (US)

(72) Inventor: Yun Ho Lee, Pleasanton, CA (US)

(21) Appl. No.: 15/793,918

(22) Filed: Oct. 25, 2017

(51) Int. Cl. H01Q 1/32; G01S 13/89; H01Q 3/34

(52) U.S. Cl. CPC H01Q 1/3233; G01S 2013/0245; H01Q 3/34; G01S 13/89

(57) ABSTRACT

Method and apparatus are disclosed for beamforming for wireless vehicle communication. An example vehicle includes an antenna array for beamforming, a navigation controller for determining a vehicle location and a travel route, and a beamforming controller. The beamforming controller is to identify a signal strength with a first transceiver and search, upon the signal strength being less than a threshold, for a second transceiver based on transceiver mapping information, the vehicle location, and the travel route. The beamforming controller also is to adjust the antenna array to beamform in a predicted direction to the second transceiver.

### TECHNICAL FIELD

The present disclosure generally relates to vehicle communication and, more specifically, to beamforming for wireless vehicle communication.

### BACKGROUND

Oftentimes, vehicles include antennas to establish communication links with antenna stations to communicate with external networks. For instance, a vehicle may include an antenna to establish a communication link with an antenna station to communicate with a public network (e.g., the Internet), a private network (e.g., an intranet), or combinations thereof. The antenna of the vehicle communicatively may couple to different antenna stations as the vehicle travels along a road. For instance, the antenna communicatively couples to one antenna station for communication with external networks when the vehicle is at one location and communicatively couples to another antenna station for communication with external networks when the vehicle is at another location.

### SUMMARY

The appended claims define this application. The present disclosure summarizes aspects of the embodiments and should not be used to limit the claims. Other implementations are contemplated in accordance with the techniques described herein, as will be apparent to one having ordinary skill in the art upon examination of the following drawings and detailed description, and these implementations are intended to be within the scope of this application.

Example embodiments are shown for beamforming for wireless vehicle communication. An example disclosed vehicle includes an antenna array for beamforming, a navigation controller for determining a vehicle location and a travel route, and a beamforming controller. The beamforming controller is to identify a signal strength with a first transceiver and search, upon the signal strength being less than a threshold, for a second transceiver based on transceiver mapping information, the vehicle location, and the travel route. The beamforming controller also is to adjust the antenna array to beamform in a predicted direction to the second transceiver.

An example disclosed method includes determining, via a navigation controller, a location and a travel route of a vehicle and identifying, via a processor, a signal strength of a vehicle antenna array with a first transceiver. The example disclosed method also includes searching, when the signal strength is less than a threshold, for a second transceiver based on transceiver mapping information, the vehicle location, and the travel route and adjusting the vehicle antenna array to beamform in a predicted direction to the second transceiver.

An example disclosed system includes a vehicle including a navigation controller for determining vehicle data including a vehicle location and a travel route and a first antenna array to transmit the vehicle data. The example disclosed system also includes a base transceiver station including a second antenna array. The based transceiver station is configured to receive the vehicle data from the first antenna array, identify a signal strength between the first antenna array and the second antenna array, and adjust, upon determining that the signal strength is less than a threshold, the second antenna array to beamform in a predicted direction toward the vehicle based upon the vehicle data.

### BRIEF DESCRIPTION OF THE DRAWINGS

For a better understanding of the invention, reference may be made to embodiments shown in the following drawings. The components in the drawings are not necessarily to scale and related elements may be omitted, or in some instances proportions may have been exaggerated, so as to emphasize and clearly illustrate the novel features described herein. In addition, system components can be variously arranged, as known in the art. Further, in the drawings, like reference numerals designate corresponding parts throughout the several views.

FIG. 1 illustrates an example vehicle in accordance with the teachings herein.

FIG. 2 depicts the vehicle of FIG. 1 travelling along a road in proximity to wireless transceivers.

FIG. 3 depicts a grid of beamforming directions of an antenna array of the vehicle of FIG. 1.

FIG. 4 depicts example beamforming directions of an antenna array of the vehicle of FIG. 1 relative to a wireless transceiver.

FIG. 5 depicts other example beamforming directions of an antenna array of the vehicle of FIG. 1 relative to a wireless transceiver.

FIG. 6 is a block diagram of electronic components of the vehicle of FIG. 1.

FIG. 7 is a flowchart for adapting beamforming of an antenna array of a vehicle for wireless communication in accordance with the teachings herein.

### DETAILED DESCRIPTION OF EXAMPLE EMBODIMENTS

While the invention may be embodied in various forms, there are shown in the drawings, and will hereinafter be described, some exemplary and non-limiting embodiments, with the understanding that the present disclosure is to be considered an exemplification of the invention and is not intended to limit the invention to the specific embodiments illustrated.

Oftentimes, vehicles include antennas to establish communication links with antenna stations to communicate with external networks. For instance, a vehicle may include an antenna to establish a communication link with an antenna station to communicate with a public network (e.g., the Internet), a private network (e.g., an intranet), or combinations thereof. The antenna of the vehicle communicatively may couple to different antenna stations as the vehicle travels along a road. For instance, the antenna communicatively couples to one antenna station for communication with external networks when the vehicle is at one location and communicatively couples to another antenna station for communication with external networks when the vehicle is at another location. In some instances, the vehicle potentially may become temporarily disconnected from the external networks as the vehicle travels from one location to another as a result of a communication link with one transceiver ending and a communication link with another transceiver yet to be established.

Example methods and apparatus disclosed herein include a vehicle having an antenna array and a beamforming controller in which the beamforming controller controls beamforming of the antenna array to maintain a communication link with external network(s) via transceiver(s) as the vehicle travels along road(s). The beamforming controller monitors a signal strength the communication link of the antenna array and adjusts a beamforming direction of the antenna array to maintain a strong communication link with a first transceiver and/or to establish a strong communication link with a second transceiver such that the signal strength of the communication link of the antenna array with external network(s) remains above a threshold level as the vehicle travels along the road(s). Further, the beamforming controller is to predict a location of the second transceiver and adjust the antenna array to beamform in a predicted direction toward the predicted location of the second to quickly establish a communication link with the second transceiver such that the time it takes to establish the communication link with the second transceiver is reduced. By quickly establishing communication link(s) with transceiver(s), the example methods and apparatus disclosed herein reduce gaps in wireless communication coverage as the vehicle travels along the road(s), for example, when the vehicle is moving quickly and, thus, a direction to a transceiver is changing quickly.

Examples disclosed herein include a vehicle system for establishing a communication link between a vehicle and a transceiver via beamforming. The vehicle system includes an array antenna that is configured to beamform. The vehicle system collects vehicle data (e.g., a speed, a GPS location, a vehicle projection, navigation data, driving history, etc.) and transceiver data (e.g., a map of transceiver locations, antenna array orientations of transceivers, etc.). Based upon the collected data, the vehicle system determines whether the antenna array is able to establish a communication link with a transceiver having a signal strength above a predetermined threshold. In response to the vehicle system identifying such a transceiver, the vehicle system adjusts the array antenna to beamform in a predicted direction toward a predicted location of the identified transceiver to establish a communication link with the transceiver. In response to the vehicle system being unable to identify such a transceiver, the vehicle system adjusts the array antenna to beamform in a default direction. The vehicle system adjusts a beamforming direction from the predicted direction and/or the default direction until a communication link is established between the antenna array and a transceiver. Further, the vehicle system subsequently tracks a signal strength of the communication link between the antenna array and the transceiver. If the signal strength becomes less than the predetermined threshold, the vehicle system attempts to identify another transceiver based on the collected data and readjusts the beamforming direction until a communication link is established with another transceiver. Further, in some examples, one or more transceivers collect (e.g., via a network and/or others of the transceivers) and utilize the vehicle data (e.g., a speed, a GPS location, a vehicle projection, navigation data, driving history, etc.) to predict a direction to the vehicle. In some such examples, a transceiver adjusts a beamforming direction of its antenna array to facilitate establishing a communication link with the vehicle.

As used herein, “beamforming” refers to a signal processing technique for an antenna array in which a signal strength of the antenna array is increased in a direction (referred to as a beamforming direction) by causing signals emitted in some directions to experience destructive interference and signals emitted in other directions to experience constructive interference. For example, beamforming may be performed to increase a signal strength of an antenna array that includes omnidirectional antennas in a beamforming direction. As used herein, an “antenna array” refers to a set of antennas that are operatively coupled together to transmit and/or receive signals. As used herein, an “omnidirectional antenna” refers to an antenna that emits a signal uniformly in each direction of a plane. As used herein, a “beamforming direction” refers to a direction in which an antenna array transmits and/or receives signals via beamforming.

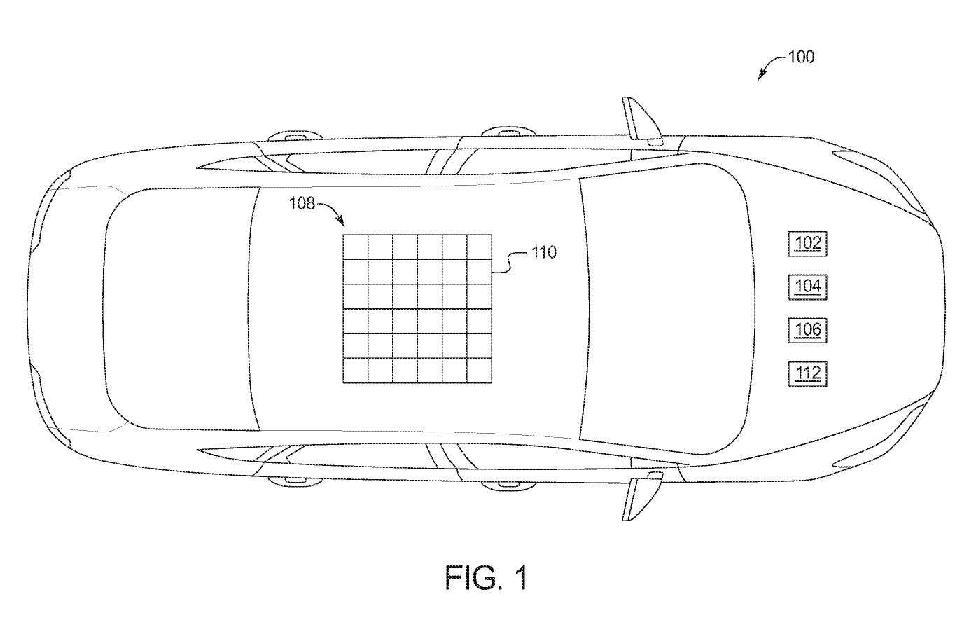

Turning to the figures, FIG. 1 illustrates an example vehicle 100 in accordance with the teachings herein. The vehicle 100 may be a standard gasoline powered vehicle, a hybrid vehicle, an electric vehicle, a fuel cell vehicle, and/or any other mobility implement type of vehicle. The vehicle 100 includes parts related to mobility, such as a powertrain with an engine, a transmission, a suspension, a driveshaft, and/or wheels, etc. The vehicle 100 may be non-autonomous, semi-autonomous (e.g., some routine motive functions controlled by the vehicle 100), or autonomous (e.g., motive functions are controlled by the vehicle 100 without direct driver input).

In the illustrated example, the vehicle 100 includes a vehicle speed sensor 102 and a global positioning system (GPS) receiver 104. The vehicle speed sensor 102 measures a speed at which the vehicle 100 is travelling. Further, in some examples, the vehicle speed sensor 102 determines an acceleration or deceleration of the vehicle 100 based on the speed measurements captured by the vehicle speed sensor 102. The GPS receiver 104 receives a signal from a global positioning system to determine a location of the vehicle 100.

Further, the vehicle 100 of the illustrated example includes a navigation controller 106. For example, the navigation controller 106 determines the location of the vehicle 100 based upon the signal received via the GPS receiver 104. Additionally or alternatively, the navigation controller 106 determines and/or monitors a travel route of the vehicle 100. For example, the navigation controller 106 identifies the current position of the vehicle 100 along and/or relative to the travel route of the vehicle 100. In some examples, the navigation controller 106 monitors a travel route that was provided by an operator (e.g., a driver) of the vehicle 100 via an input device. In some examples, the navigation controller 106 determines a travel route based upon the current position of the vehicle 100 and a destination that was provided by the vehicle operator via an input device. In some examples, the navigation controller 106 determines a predicted travel route based upon a driving history of the vehicle 100 and/or the operator of the vehicle 100. For example, if the location of the vehicle 100 is associated with a work site of the vehicle operator, the navigation controller 106 determines that the travel route to a home of the vehicle operator. Further, in some examples, the navigation controller 106 determines the travel route based upon a personal calendar of the vehicle operator, traffic data, map data, weather condition data, and/or any other data that affects a travel route from a current location to a target destination.

In the illustrated example, the vehicle 100 also includes an antenna array 108 that includes a plurality of antennas 110 and a beamforming controller 112. The antennas 110 of the antenna array 108 include, for example, omnidirectional antenna(s) and/or directional antenna(s). In some examples, the antennas 110 are arranged in a tiled pattern (e.g., a square, a rectangle, a circle, etc.) on a copper pad and/or plate (e.g., located on a sheet of PCB and/or other insulating material) to form the antenna array 108. The antennas 110 are operatively coupled together to enable the antenna array 108 to receive and/or transmit signals. For example, the antennas 110 are operatively coupled together to enable the antenna array 108 to communicatively couple to a base transceiver station.

Further, the beamforming controller 112 controls operation of the antenna array 108. For example, the beamforming controller 112 identifies a direction in which the antenna array 108 is to receive and/or transmit signals and causes the antenna array 108 to beamform signals in that direction. In some examples, the beamforming controller 112 causes the antenna array 108 to beamform signals in a beamforming direction to increase a signal strength of the signals received and/or transmitted by the antennas 110 of the antenna array 108 in the beamforming direction. For example, the beamforming controller 112 adjusts a beamforming direction of the antenna array 108 by adjusting an elevation angle and/or an azimuth angle of the beamforming direction of the antenna array 108. The beamforming controller 112 adjusts the elevation angle and/or the azimuth angle of the beamforming direction of the antenna array 108 by adjusting a signal phase of one or more of the antennas 110 of the antenna array 108. For example, by adjusting a signal phase of one or more of the antennas 110, the beamforming controller 112 adjusts which signal directions experience destructive interference and/or constructive interference.

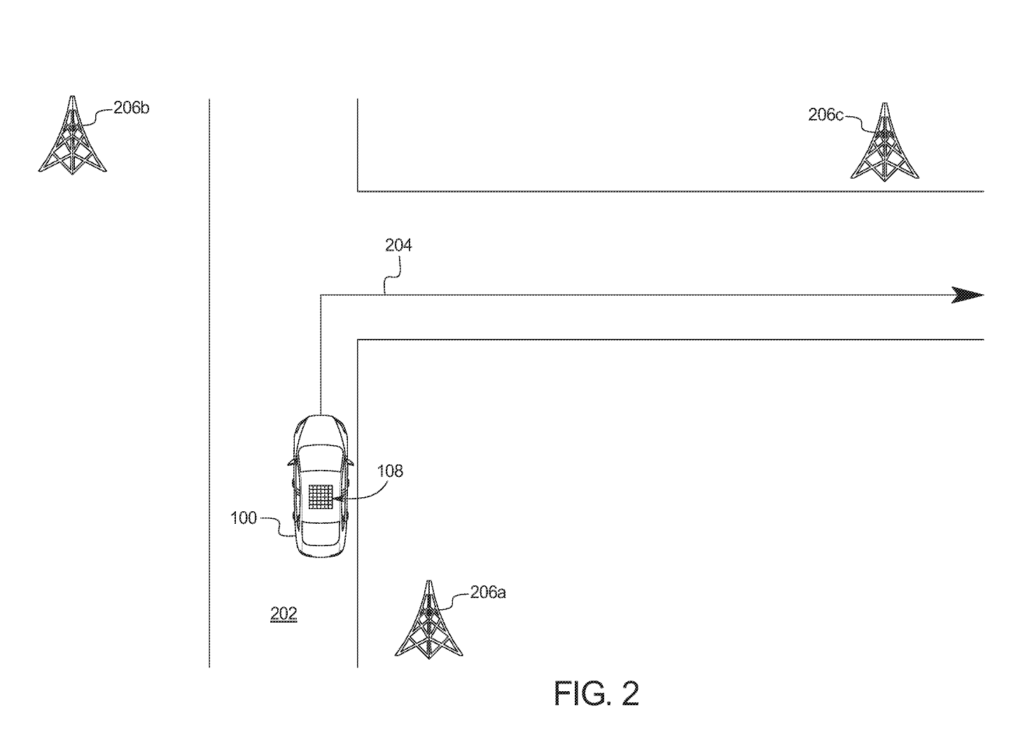

FIG. 2 depicts the vehicle 100 travelling on a road 202 along a travel route 204 in proximity to transceivers 206 (also referred to as wireless transceivers or base transceiver stations). In the illustrated example, the transceivers 206 include a transceiver 206a (e.g., a first transceiver), a transceiver 206b (e.g., a second transceiver), and a transceiver 206c (e.g., a third transceiver). In other examples, the transceivers 206 may include more, less, and/or different transceivers that are located in proximity to the vehicle 100 as the vehicle 100 travels on the road 202.

In the illustrated example, the antenna array 108 of the vehicle 100 is configured to wirelessly communicatively couple with one or more of the transceivers 206. Further, the antenna array 108 is configured to beamform in directions toward the transceivers 206 to communicatively couple with the transceivers 206. For example, the antenna array 108 beamforms in a direction toward the transceiver 206a to communicatively couple with the transceiver 206a, in a direction toward the transceiver 206b to communicatively couple with the transceiver 206b, in a direction toward the transceiver 206c to communicatively couple with the transceiver 206c, etc.

Further, the beamforming controller 112 of the vehicle 100 controls beamforming of the antenna array 108 to maintain a signal for wireless communication as the vehicle 100 travels along the road 202. For example, the beamforming controller 112 monitors a signal strength of the antenna array 108 and adjusts a beamforming direction of the antenna array 108 to cause the signal strength of the wireless communication with the transceivers 206 to remain above a threshold level (e.g., a static or absolute threshold, a variable or relative threshold) as the vehicle 100 travels along the road 202.

In the illustrated example, the antenna array 108 the vehicle 100 is communicatively coupled to the transceiver 206a as the vehicle 100 drives past the transceiver 206a along the road 202. For example, the antenna array 108 beamforms in a direction toward the transceiver 206a as the vehicle 100 approaches, passes, and moves beyond the transceiver 206a. The beamforming controller 112 identifies a signal strength of the wireless communication between the antenna array 108 and the transceiver 206a while the antenna array 108 is communicatively coupled to the transceiver 206a. For example, the beamforming controller 112 is configured to determine the signal strength of wireless communication with the transceivers 206 via receive signal strength indicators (RSSIs), angles-of-arrival, times-of-flight, GPS, etc.

As the vehicle 100 of the illustrated example moves away from the transceiver 206a, the signal strength of wireless communication between the antenna array 108 and the transceiver 206a decreases due to the increased distance and/or a presence of an obstacle between the vehicle 100 and the transceiver 206a. Further, the beamforming controller 112 compares the signal strength of the wireless communication with the transceiver 206a to a threshold signal strength. Responsive to determining that the signal strength between the antenna array 108 and the transceiver 206a is less than the threshold signal strength, the beamforming controller 112 searches for another of the transceivers 206 with which to communicatively couple. For example, by searching for another of the transceivers 206 upon the signal strength being less than the threshold signal strength, the beamforming controller 112 maintains reliable communication between the antenna array 108 and the transceiver 206a. That is, the beamforming controller 112 searches for another of the transceivers 206 when the signal strength is below the threshold signal strength to maintain a strong communication link as the vehicle 100 travels along the road 202.

To enable the beamforming controller 112 to quickly find another of the transceivers 206 without disrupting wireless communication of the antenna array 108, the beamforming controller 112 searches for another of the transceivers 206 based upon vehicle information and/or transceiver mapping information. For example, the beamforming controller 112 predicts a location of the one of the transceivers 206 to which to communicatively couple based upon a location, a travel route, a speed, an acceleration, and/or any other vehicle information of the vehicle 100 as the vehicle 100 travels along the road 202. Additionally or alternatively, the beamforming controller 112 predicts a location of the one of the transceivers 206 to which to communicatively couple based upon locations of the transceivers 206, antenna array orientations of the transceivers 206, and/or any other transceiver mapping information that is collected by the beamforming controller 112.

The beamforming controller 112 of the illustrated example selects which of the transceivers 206 to communicatively couple with the antenna array 108 based upon predicted signal strengths of wireless communication with the transceivers 206. For example, when the beamforming controller 112 determines that the signal strength between the antenna array 108 and the transceiver 206a is below the threshold signal strength, the beamforming controller 112 identifies the transceivers 206b, 206c based upon the vehicle information and/or the transceiver mapping information and determines whether to communicatively couple to the transceiver 206b or the transceiver 206c based upon respective predicted signal strengths of the transceivers 206b, 206c. That is, the beamforming controller 112 determines to adjust the antenna array 108 to beamform in a predicted direction toward one of the transceivers 206 (e.g., the transceiver 206b) responsive to determining that a predicted signal strength with that one of the transceivers 206 (e.g., a second signal strength) is greater than the threshold. Additionally or alternatively, the beamforming controller 112 determines to adjust the antenna array 108 from beamforming toward a first one of the transceivers 206 (e.g., the transceiver 206a) to a second one of the transceivers 206 (e.g., the transceiver 206b) responsive to determining that a predicted signal strength of the second one of the transceivers 206 (e.g., a second signal strength) is greater than a current signal strength of the first one of the transceivers 206.

The beamforming controller 112 predicts the signal strengths of the transceivers 206 to which the antenna array 108 is yet to be communicatively coupled based upon, for example, the vehicle information of the vehicle 100 and/or the transceiver mapping information of the transceivers 206. In some examples, the beamforming controller 112 selects which of the transceivers 206 to communicatively couple with the antenna array 108 based upon which of the transceivers 206 are predicts to be near a larger portion of the travel route 204. For example, because the travel route 204 of the vehicle 100 in FIG. 2, turns away from the transceiver 206b and toward the transceiver 206c, the beamforming controller 112 may elect to adjust a beamforming direction to communicatively couple with the transceiver 206c.

Upon identifying one of the transceivers 206 to which the antenna array 108 is to communicatively couple, the beamforming controller 112 adjust the antenna array 108 to beamform in a predicted direction toward a predicted location of the one of the transceivers 206 to which the antenna array 108 is to communicatively couple. For example, the beamforming controller 112 determines the predicted direction based upon the vehicle information and/or the transceiver mapping information. If a communicative coupling is not established when the antenna array 108 is beamforming in the predicted direction, the beamforming controller 112 further adjusts the beamforming direction (e.g., along an outward spiral path in a clockwise or counterclockwise direction) until a communicative coupling is made between the antenna array 108 and one of the transceivers 206. Further, upon establishing a communicative coupling between the antenna array 108 and one of the transceivers 206, the beamforming controller 112 monitors a current signal strength of the communicative coupling.

Further, in some examples, the beamforming controller 112 determines a confidence score for each of the predicted signal strengths of the transceivers 206. For example, the beamforming controller 112 determines to adjust the antenna array 108 to beamform in a predicted direction toward one of the transceivers 206 responsive to determining that the predicted signal strength is greater than the threshold signal strength and the confidence score of the predicted signal strength is greater than a threshold confidence score. The beamforming controller 112 may determine the confidence score based upon the vehicle information of the vehicle 100 and/or the transceiver mapping information of the transceivers 206. In some examples, when the beamforming controller 112 is unable to identify one of the transceivers 206 having a predicted signal strength greater than the threshold signal strength with a confidence score greater than a threshold confidence score, the beamforming controller 112 adjusts an antenna array to beamform in a default direction. The beamforming controller 112 further adjusts the beamforming direction (e.g., along an outward spiral path in a clockwise or counterclockwise direction) until a communicative coupling is made between the antenna array 108 and one of the transceivers 206.

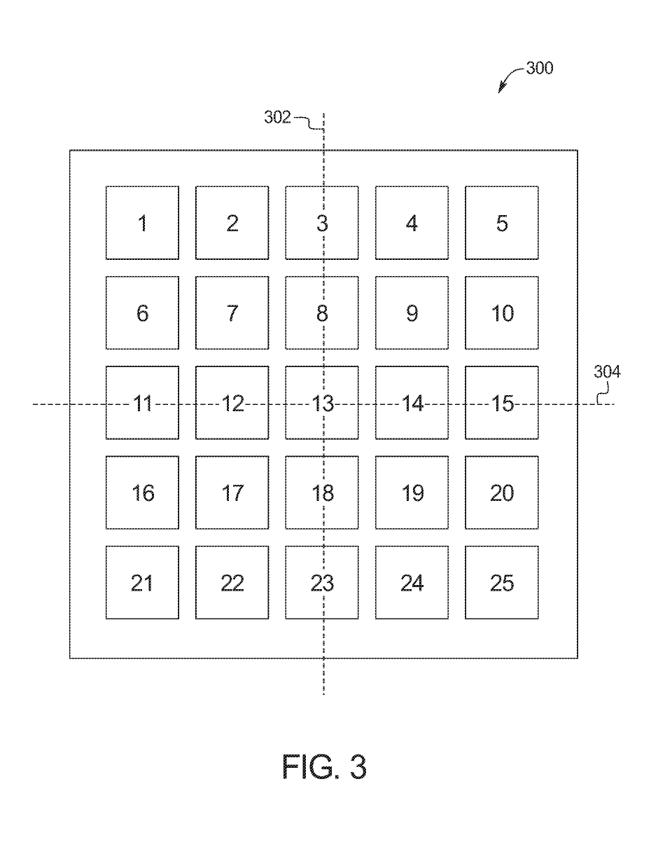

FIG. 3 depicts a grid 300 of beamforming directions of the antenna array 108 of the vehicle 100. For example, the beamforming controller 112 adjusts a beamforming direction of the antenna array 108 to communicatively couple to a transceiver (e.g., one of the transceivers 206 of FIG. 2). In some examples, the beamforming controller 112 determines the beamforming direction of the antenna array 108 based upon an orientation of an antenna array of the transceiver to which the antenna array 108 is to communicatively couple.

In the illustrated example, the grid 300 of the beamforming directions of the antenna array 108 is defined with respect to an elevation axis 302 and an azimuth axis 304. For example, the beamforming controller 112 adjusts the beamforming direction of the antenna array 108 by adjusting an elevation angle of the beamforming direction along the elevation axis 302 and/or by adjusting an azimuth angle of the beamforming direction along the azimuth axis 304. The elevation axis 302 and the azimuth axis 304 extend along a plane (e.g., a horizon, a face of the antenna array 108 of the vehicle 100, a face of an antenna array of a transceiver, etc.).

The grid 300 of the illustrated example includes blocks that correspond to beamforming directions define relative to the elevation axis 302 and the azimuth axis 304. For example, block 13 represents an origin point corresponding to a beamforming direction that is perpendicular to the plane along which the elevation axis 302 and the azimuth axis 304 are defined. That is, block 13 corresponds to a beamforming direction that is rotated 0° along the elevation axis 302 and 0° along the azimuth axis 304. In some examples, block 13 is the default position to which the beamforming controller 112 sets the beamforming direction in response to the beamforming controller 112 not identifying a nearby transceiver based upon the collected vehicle information and/or antenna information.

For example, block 8 corresponds to a beamforming direction that is rotated a first predetermined amount (e.g., 22.5°) in a first direction along the elevation axis 302 and 0° along the azimuth axis 304; block 3 corresponds to a beamforming direction that is rotated a second predetermined amount (e.g.,) 45° in the first direction along the elevation axis 302 and 0° along the azimuth axis 304; block 18 corresponds to a beamforming direction that is rotated the first predetermined amount in a second direction along the elevation axis 302 and 0° along the azimuth axis 304; and block 23 corresponds to a beamforming direction that is rotated the second predetermined amount in the second direction along the elevation axis 302 and 0° along the azimuth axis 304.

For example, block 12 corresponds to a beamforming direction that is rotated the first predetermined amount in a first direction along the azimuth axis 304 and 0° along the elevation axis 302; block 11 corresponds to a beamforming direction that is rotated a second predetermined amount in the first direction along the azimuth axis 304 and 0° along the elevation axis 302; block 14 corresponds to a beamforming direction that is rotated the first predetermined amount in a second direction along the azimuth axis 304 and 0° along the elevation axis 302; and block 15 corresponds to a beamforming direction that is rotated a second predetermined amount in the second direction along the azimuth axis 304 and 0° along the elevation axis 302.

For example, block 7 corresponds to a beamforming direction that is rotated the first predetermined amount in the first direction along the elevation axis 302 and in the first direction along the azimuth axis 304; block 1 corresponds to a beamforming direction that is rotated the second predetermined amount in the first direction along the elevation axis 302 and in the first direction along the azimuth axis 304; block 9 corresponds to a beamforming direction that is rotated the first predetermined amount in the first direction along the elevation axis 302 and in the second direction along the azimuth axis 304; block 5 corresponds to a beamforming direction that is rotated the second predetermined amount in the first direction along the elevation axis 302 and in the second direction along the azimuth axis 304; block 19 corresponds to a beamforming direction that is rotated the first predetermined amount in the second direction along the elevation axis 302 and in the second direction along the azimuth axis 304; block 25 corresponds to a beamforming direction that is rotated the second predetermined amount in the second direction along the elevation axis 302 and in the second direction along the azimuth axis 304; block 17 corresponds to a beamforming direction that is rotated the first predetermined amount in the second direction along the elevation axis 302 and in the first direction along the azimuth axis 304; and block 21 corresponds to a beamforming direction that is rotated the second predetermined amount in the second direction along the elevation axis 302 and in the first direction along the azimuth axis 304.

For example, block 2 corresponds to a beamforming direction that is rotated the first predetermined amount in the first direction along the elevation axis 302 and is rotated the second predetermined amount in the first direction along the azimuth axis 304; block 2 corresponds to a beamforming direction that is rotated the second predetermined amount in the first direction along the elevation axis 302 and is rotated the first predetermined amount in the first direction along the azimuth axis 304; block 4 corresponds to a beamforming direction that is rotated the second predetermined amount in the first direction along the elevation axis 302 and is rotated the first predetermined amount in the second direction along the azimuth axis 304; block 10 corresponds to a beamforming direction that is rotated the first predetermined amount in the first direction along the elevation axis 302 and is rotated the second predetermined amount in the second direction along the azimuth axis 304; block 20 corresponds to a beamforming direction that is rotated the first predetermined amount in the second direction along the elevation axis 302 and is rotated the second predetermined amount in the second direction along the azimuth axis 304; block 24 corresponds to a beamforming direction that is rotated the second predetermined amount in the second direction along the elevation axis 302 and is rotated the first predetermined amount in the second direction along the azimuth axis 304; block 22 corresponds to a beamforming direction that is rotated the second predetermined amount in the second direction along the elevation axis 302 and is rotated the first predetermined amount in the first direction along the azimuth axis 304; and block 16 corresponds to a beamforming direction that is rotated the first predetermined amount in the second direction along the elevation axis 302 and is rotated the second predetermined amount in the first direction along the azimuth axis 304.

In some examples, the beamforming controller 112 adjusts the beamforming direction from an initial position (e.g., a predicted direction to a transceiver, a default position) along the grid 300 until the antenna array 108 communicatively couples to a transceiver. For example, the beamforming controller 112 adjusts the beamforming direction of the antenna array 108 from an initial position of the grid 300 in an outward spiral path about the initial position until the antenna array 108 communicatively couples with another transceiver (e.g., a second transceiver). For example, if the beamforming controller 112 determines that the initial position is block 12 of the grid 300, the beamforming controller 112 adjusts the beamforming direction from block 12, to block 11, to block 7, to block 13, to block 17, to block 6, to block 8, to block 18, to block 16, to block 1, to block 2, to block 3, etc. until the beamforming controller 112 detects that the antenna array 108 has communicatively coupled to a transceiver.

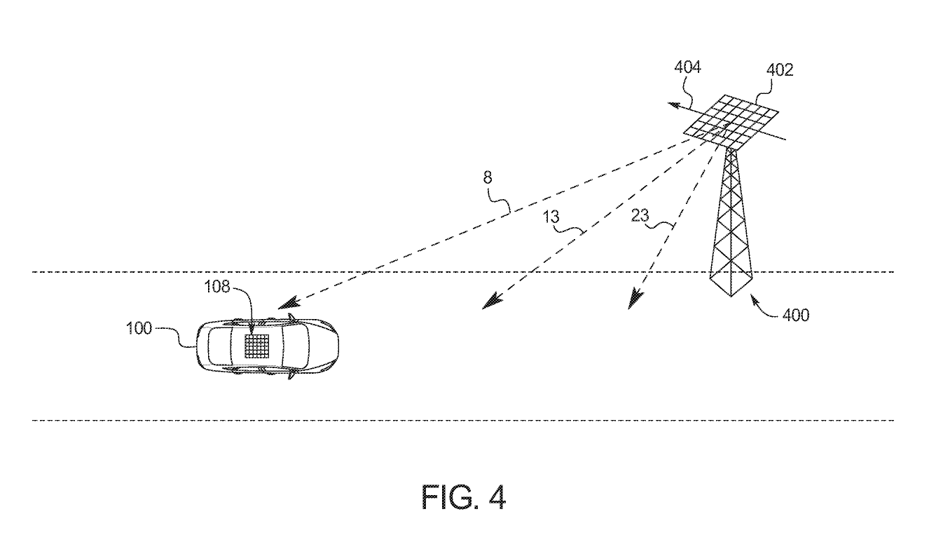

FIG. 4 depicts example beamforming directions of the antenna array 108 of the vehicle 100 for wirelessly communicatively coupling with a base transceiver station 400. The base transceiver station 400 represents, for example, the transceiver 206a, the transceiver 206b, the transceiver 206c, and/or any other of the transceivers 206 that is configured to communicatively couple to the antenna array 108 of the vehicle 100. The base transceiver station 400 of the illustrated example includes an antenna array 402 that is configured to wirelessly communicatively couple to the antenna array 108 of the vehicle 100. For example, the antenna array 402 includes a plurality of antennas that include, for example, omnidirectional antenna(s) and/or directional antenna(s). In some examples, the antennas 110 are arranged in a tiled pattern (e.g., a square, a rectangle, a circle, etc.) on a copper pad and/or plate (e.g., located on a sheet of PCB and/or other insulating material) to form the antenna array 402. The antennas are operatively coupled together to enable the antenna array 402 to receive and/or transmit signals. For example, the antennas are operatively coupled together to enable the antenna array 402 to beamform signals (e.g., toward the vehicle 100).

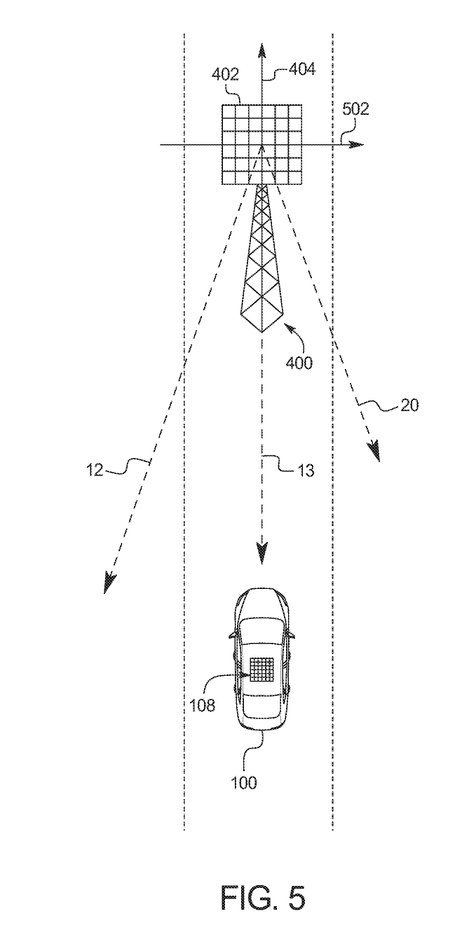

In the illustrated example, the beamforming directions (e.g., the beamforming directions of the grid 300 of FIG. 3) are defined with respect to a plane that extends along a face of the antenna array 402 of the base transceiver station 400. For example, the beamforming directions 8, 13, 23 depicted in FIG. 4 of the antenna array 108 of the vehicle 100 have varying elevation angles relative to an elevation axis 404 that extends along the face of the antenna array 402 of the base transceiver station 400. Additionally or alternatively, the beamforming directions 8, 13, 23 of the antenna array 108 of the vehicle 100 have varying azimuth angles relative to an azimuth axis (e.g., an azimuth axis 502 of FIG. 5) that extends along the face of the antenna array 402.

For example, the beamforming controller 112 of the vehicle 100 determines a beamforming direction of the antenna array 108 based upon an orientation of the antenna array 402 of the base transceiver station 400. For example, when the vehicle 100 is in a first position relative to the base transceiver station 400 as depicted in FIG. 4, the beamforming controller 112 adjusts the antenna array 108 to beamform in the beamforming direction 8 to communicatively couple to the antenna array 402 of the base transceiver station 400. When the vehicle 100 is in a second position that is closer to the base transceiver station 400, the beamforming controller 112 is to adjust the antenna array 108 to beamform in the beamforming direction 13 to communicatively couple with the base transceiver station 400. Further, when the vehicle 100 is in a third position that is closer to the base transceiver station 400, the beamforming controller 112 is to adjust the antenna array 108 to beamform in the beamforming direction 23 to communicatively couple with the base transceiver station 400.

Additionally or alternatively, the transceiver 402 collects the vehicle data of the vehicle, for example, via a network, one of the transceivers 206 communicatively coupled to the vehicle 100, and/or another communication link with the vehicle 100. In such examples, the transceiver 402 includes a beamforming controller (e.g., identical or substantially similar to the beamforming controller 112 of the vehicle 100) that utilizes the collected vehicle data to predict a direction to the vehicle 100. That is, the vehicle 100 transmits (e.g., via the antenna array 108 and/or another communication module) the vehicle data to a network, the transceiver 402, and/or another one of the transceivers 206 to enable a beamforming controller of the transceiver 402 to predict a location of the vehicle 100. If the beamforming controller of the transceiver 402 is able to predict a location of the vehicle 100 based on the vehicle data, the beamforming controller of the transceiver 402 adjusts the antenna array 402 to beamform in the predicted direction to the vehicle 100 to facilitate establishing a communication link with the vehicle 100. Otherwise, if the beamforming controller of the transceiver 402 is unable to predict a location of the vehicle 100 based on the vehicle data, the beamforming controller of the transceiver 402 adjusts the antenna array 402 to beamform in a default direction. Further, the beamforming controller of the transceiver 402 adjusts the beamforming direction of the antenna array 402 in an outward spiral path from the predicted direction and/or the default direction until the antenna array 402 of the transceiver 402 communicatively couples to the antenna array 108 of the vehicle 100.

FIG. 5 also depicts example beamforming directions of the antenna array 108 of the vehicle 100 for wirelessly communicatively coupling with the base transceiver station 400. In the illustrated example, the beamforming directions (e.g., the beamforming directions of the grid 300 of FIG. 3) are defined with respect to a plane that extends along a face of the antenna array 402 of the base transceiver station 400. For example, the beamforming directions 12, 13, 20 depicted in FIG. 5 of the antenna array 108 of the vehicle 100 have varying elevation angles relative to the elevation axis 404 and/or azimuth angles relative to an azimuth axis 502. As illustrated in FIG. 5, the elevation axis 404 and the azimuth axis 502 extend along the face of the antenna array 402 of the base transceiver station 400.

For example, the beamforming controller 112 of the vehicle 100 determines a beamforming direction of the antenna array 108 based upon an orientation of the antenna array 402 of the base transceiver station 400. For example, when the vehicle 100 is in the second position relative to the base transceiver station 400 as depicted in FIG. 5, the beamforming controller 112 adjusts the antenna array 108 to beamform in the beamforming direction 13 to communicatively couple to the antenna array 402 of the base transceiver station 400. When the vehicle 100 is in a fourth position that is closer to the base transceiver station 400 and offset from the elevation axis 404 in a first direction, the beamforming controller 112 is to adjust the antenna array 108 to beamform in the beamforming direction 12 to communicatively couple with the base transceiver station 400. Further, when the vehicle 100 is in a fifth position that is closer to the base transceiver station 400 and offset from the elevation axis 404 in a second direction, the beamforming controller 112 is to adjust the antenna array 108 to beamform in the beamforming direction 20 to communicatively couple with the base transceiver station 400.

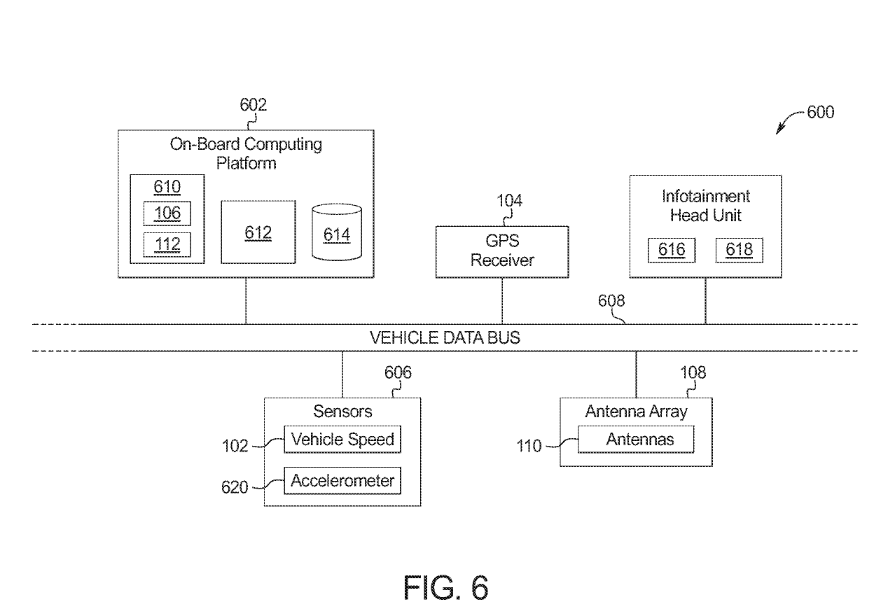

FIG. 6 is a block diagram of electronic components 600 of the vehicle 100. As illustrated in FIG. 6, the electronic components 600 include an on-board computing platform 602, the GPS receiver 104, an infotainment head unit 604, sensors 606, and the antenna array 108 that includes the antennas 110.

The on-board computing platform 602 includes a microcontroller unit, controller or processor 610, memory 612, and a database 614. In some examples, the processor 610 of the on-board computing platform 602 is structured to include the navigation controller 106 and/or the beamforming controller 112. Alternatively, in some examples, the navigation controller 106 and/or the beamforming controller 112 are incorporated into another electronic control unit (ECU) with its own processor 610, memory 612, and database 614. The database 614 stores, for example, entries that correlate beamforming directions to the transceiver mapping information, transceiver antenna-array orientation information, other transceiver data, the vehicle location, the travel route, the vehicle speed, the vehicle acceleration, and/or other vehicle data. For example, the beamforming controller 112 retrieves a predicted direction to a transceiver based upon transceiver data and/or vehicle data collected by the beamforming controller 112.

The processor 610 may be any suitable processing device or set of processing devices such as, but not limited to, a microprocessor, a microcontroller-based platform, an integrated circuit, one or more field programmable gate arrays (FPGAs), and/or one or more application-specific integrated circuits (ASICs). The memory 612 may be volatile memory (e.g., RAM including non-volatile RAM, magnetic RAM, ferroelectric RAM, etc.), non-volatile memory (e.g., disk memory, FLASH memory, EPROMs, EEPROMs, memristor-based non-volatile solid-state memory, etc.), unalterable memory (e.g., EPROMs), read-only memory, and/or high-capacity storage devices (e.g., hard drives, solid state drives, etc). In some examples, the memory 612 includes multiple kinds of memory, particularly volatile memory and non-volatile memory.

The memory 612 is computer readable media on which one or more sets of instructions, such as the software for operating the methods of the present disclosure, can be embedded. The instructions may embody one or more of the methods or logic as described herein. For example, the instructions reside completely, or at least partially, within any one or more of the memory 612, the computer readable medium, and/or within the processor 610 during execution of the instructions.

The terms “non-transitory computer-readable medium” and “computer-readable medium” include a single medium or multiple media, such as a centralized or distributed database, and/or associated caches and servers that store one or more sets of instructions. Further, the terms “non-transitory computer-readable medium” and “computer-readable medium” include any tangible medium that is capable of storing, encoding or carrying a set of instructions for execution by a processor or that cause a system to perform any one or more of the methods or operations disclosed herein. As used herein, the term “computer readable medium” is expressly defined to include any type of computer readable storage device and/or storage disk and to exclude propagating signals.

The infotainment head unit 604 provides an interface between the vehicle 100 and a user. The infotainment head unit 604 includes digital and/or analog interfaces (e.g., input devices and output devices) to receive input from and display information for the user(s). The input devices include, for example, a control knob, an instrument panel, a digital camera for image capture and/or visual command recognition, a touch screen, an audio input device (e.g., cabin microphone), buttons, or a touchpad. The output devices may include instrument cluster outputs (e.g., dials, lighting devices), actuators, a heads-up display, a display 616 (e.g., a center console display such as a liquid crystal display (LCD), an organic light emitting diode (OLED) display, a flat panel display, a solid state display, etc.), and/or speakers 618. In the illustrated example, the infotainment head unit 604 includes hardware (e.g., a processor or controller, memory, storage, etc.) and software (e.g., an operating system, etc.) for an infotainment system (such as SYNC® and MyFord Touch® by Ford®). Additionally, the infotainment head unit 604 displays the infotainment system on, for example, the display 616.

The sensors 606 are arranged in and around the vehicle 100 to monitor properties of the vehicle 100 and/or an environment in which the vehicle 100 is located. One or more of the sensors 606 may be mounted to measure properties around an exterior of the vehicle 100. Additionally or alternatively, one or more of the sensors 606 may be mounted inside a cabin of the vehicle 100 or in a body of the vehicle 100 (e.g., an engine compartment, wheel wells, etc.) to measure properties in an interior of the vehicle 100. For example, the sensors 606 include odometers, tachometers, pitch and yaw sensors, wheel speed sensors, microphones, tire pressure sensors, biometric sensors and/or sensors of any other suitable type. In the illustrated example, the sensors 606 include the vehicle speed sensor 102 and an accelerometer 620. For example, the vehicle speed sensor 102 detects a speed and/or acceleration at which the vehicle 100 is travelling, and the accelerometer 620 detects an orientation of the vehicle 100.

The vehicle data bus 608 communicatively couples the GPS receiver 104, the antenna array 108, the on-board computing platform 602, the infotainment head unit 604, and the sensors 606. In some examples, the vehicle data bus 608 includes one or more data buses. The vehicle data bus 608 may be implemented in accordance with a controller area network (CAN) bus protocol as defined by International Standards Organization (ISO) 11898-1, a Media Oriented Systems Transport (MOST) bus protocol, a CAN flexible data (CAN-FD) bus protocol (ISO 11898-7) and/a K-line bus protocol (ISO 9141 and ISO 14230-1), and/or an Ethernet™ bus protocol IEEE 802.3 (2002 onwards), etc.

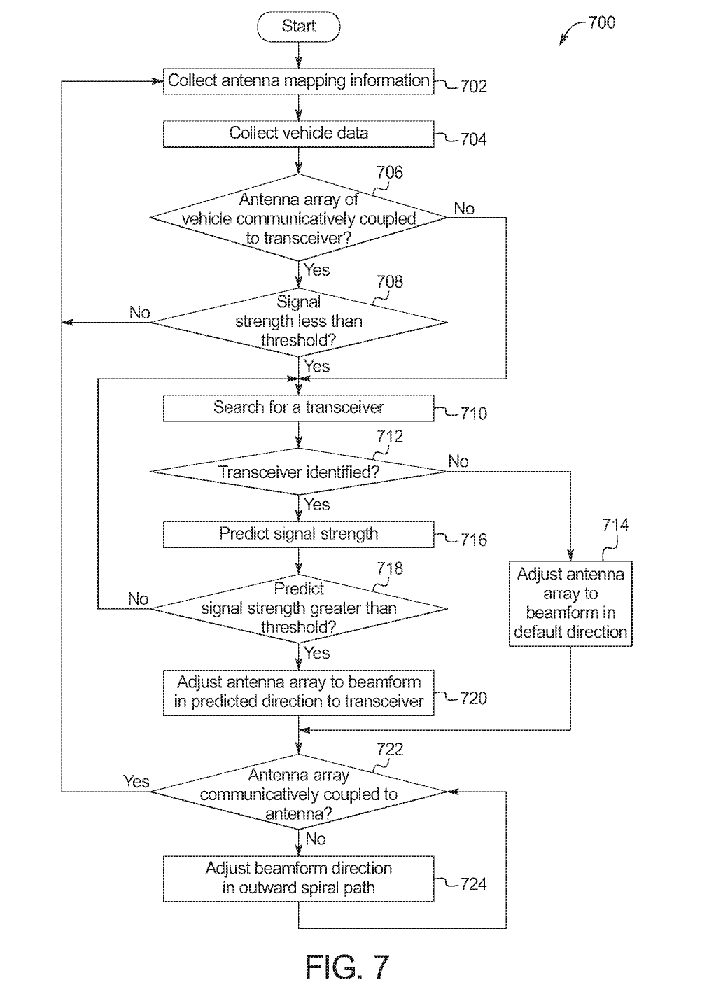

FIG. 7 is a flowchart of an example method 700 to adjust beamforming of an antenna array of a vehicle and/or a base transceiver station for wireless communication. The flowchart of FIG. 7 is representative of machine readable instructions that are stored in memory (such as the memory 612 of FIG. 6) and include one or more programs which, when executed by a processor (such as the processor 610 of FIG. 6), cause the vehicle 100 to implement the example navigation controller 106 and/or the example beamforming controller 112 of FIGS. 1 and 6. While the example program is described with reference to the flowchart illustrated in FIG. 7, many other methods of implementing the example navigation controller 106 and/or the example beamforming controller 112 may alternatively be used. For example, the order of execution of the blocks may be rearranged, changed, eliminated, and/or combined to perform the method 700. Further, because the method 700 is disclosed in connection with the components of FIGS. 1-6, some functions of those components will not be described in detail below.

Initially, at block 702, the beamforming controller 112 collects the transceiver mapping information, for example, from the memory 612 of the on-board computing platform 602 of the vehicle 100. Further, in some examples, the beamforming controller 112 collects other transceiver data, such as antenna array orientations of the transceivers 206. At block 704, the beamforming controller 112 collects vehicle data of the vehicle 100, such as a location, a predicted travel route, a speed, an acceleration, an orientation, etc. of the vehicle 100. For example, the navigation controller 106 determines the predicted travel route based on information (e.g., a target destination, a target travel route) provided by an operator of the vehicle 100 and/or a driving history of the operator and/or the vehicle 100.

At block 706, the beamforming controller 112 determines whether the antenna array 108 of the vehicle 100 is communicatively coupled to one of the transceivers 206. In response to the beamforming controller 112 determining that the antenna array 108 is not communicatively coupled to one of the transceivers 206, the method 700 proceeds to block 710. Otherwise, in response to the beamforming controller 112 determining that the antenna array 108 is communicatively coupled to one of the transceivers 206, the method 700 proceeds to block 708.

At block 708, the beamforming controller 112 determines whether a signal strength of the wireless connection between the antenna array 108 and one of the transceivers 206 (e.g., the transceiver 206a of FIG. 2) is less than a threshold strength (e.g., a static or absolute threshold, a variable or relative threshold). For example, the beamforming controller 112 determines the signal strength of signal(s) transmitted between the antenna array 108 and the one of the transceivers 206 to which the antenna array 108 is wirelessly connected via RSSI, angle-of-arrival, time-of-flight, GPS, etc. In response to the beamforming controller 112 determining that the signal strength is not less than the threshold strength, the method 700 returns to block 702. Otherwise, in response to the beamforming controller 112 determining that the signal strength is less than the threshold strength, the method 700 proceeds to block 710.

At block 710, the beamforming controller 112 searches for another one of the transceivers 206 (e.g., the transceiver 206b of FIG. 2, the transceiver 206c of FIG. 2) for wireless communication with the antenna array 108 of the vehicle 100. At block 712, the beamforming controller 112 determines whether another one of the transceivers 206 has been identified for wireless communication. In response to the beamforming controller 112 determining that there is not another one of the transceivers 206, the method 700 proceeds to block 714 at which the beamforming controller 112 adjusts the antenna array 108 in a default direction (e.g., including a default elevation direction and a default azimuth direction). Otherwise, in response to the beamforming controller 112 determining that there is another one of the transceivers 206, the method 700 proceeds to block 716.

At block 716, the beamforming controller 112 predicts a signal strength of wireless communication between the antenna array 108 and the identified one of the transceivers 206. For example, the beamforming controller 112 determines a predicted signal strength based upon a predicted direction of beamforming to the identified one of the transceivers 206. The beamforming controller 112 determines the predicted direction based upon vehicle data of the vehicle 100 (e.g., a location, a predicted travel route, a speed, an acceleration, an orientation, etc.) and/or transceiver data of the identified one of the transceivers 206 (e.g., a location, an array antenna orientation, etc.). At block 718, the beamforming controller 112 determines whether the predicted signal strength is greater than a threshold strength. In some examples, the threshold strength of block 718 is identical to the threshold strength of block 708. In other example, the threshold strengths of block 708 and block 718 are different. In response to the beamforming controller 112 determining that the predicted signal strength is not greater than the threshold strength, the method 700 returns to block 710 to search for another one of the transceivers 206. Otherwise, in response to the beamforming controller 112 determining that the predicted signal strength is greater than the threshold strength, the method 700 proceeds to block 720 at which the beamforming controller 112 adjusts the antenna array 108 to beamform in the predicted direction to the identified one of the transceivers 206.

At block 722, the beamforming controller 112 determines whether the antenna array 108 is communicatively coupled to one of the transceivers 206. In response to the beamforming controller 112 determining that the antenna array 108 is communicatively coupled to one of the transceivers 206, the method 700 returns to block 722. Otherwise, in response to the beamforming controller 112 determining that the antenna array 108 is communicatively coupled to one of the transceivers 206, the method 700 proceeds to block 724 at which the beamforming controller 112 adjusts the beamforming direction of the antenna array 108 in an outward spiral path. After the beamforming controller 112 adjusts the beamforming direction, the method 700 returns to block 722.

Additionally or alternatively, the beamforming controller 112 of the vehicle 100 transmits (e.g., via the antenna array 108 and/or another communication module) the vehicle data to a network and/or one or more of the transceivers 206. One of the transceivers 206 that is attempting to communicatively couple to the antenna array 108 of the vehicle 100 receives the vehicle data of the vehicle 100 (e.g., from the network, the vehicle 100, and/or another one of the transceivers 206). Further, a beamforming controller (e.g., identical or substantially similar to the beamforming controller 112 of the vehicle 100) of that one of the transceivers 206 utilizes the collected vehicle data to predict a direction to the vehicle 100. If the beamforming controller of that one of the transceivers 206 is able to predict a location of the vehicle 100 based on the vehicle data, the beamforming controller adjusts the antenna array (e.g., the antenna array 402) of that one of the transceivers 206 to beamform in the predicted direction to the vehicle 100. Otherwise, if the beamforming controller of that one of the transceivers 206 is unable to predict a location of the vehicle 100 based on the vehicle data, the beamforming controller adjusts the antenna array of that one of the transceivers 206 to beamform in a default direction. Further, the beamforming controller of that one of the transceivers 206 adjusts the beamforming direction of the antenna array of that one of the transceivers 206 in an outward spiral path from the predicted direction and/or the default direction until the antenna array of that one of the transceivers 206 communicatively couples to the antenna array 108 of the vehicle 100.

In this application, the use of the disjunctive is intended to include the conjunctive. The use of definite or indefinite articles is not intended to indicate cardinality. In particular, a reference to “the” object or “a” and “an” object is intended to denote also one of a possible plurality of such objects. Further, the conjunction “or” may be used to convey features that are simultaneously present instead of mutually exclusive alternatives. In other words, the conjunction “or” should be understood to include “and/or”. The terms “includes,” “including,” and “include” are inclusive and have the same scope as “comprises,” “comprising,” and “comprise” respectively.

The above-described embodiments, and particularly any “preferred” embodiments, are possible examples of implementations and merely set forth for a clear understanding of the principles of the invention. Many variations and modifications may be made to the above-described embodiment(s) without substantially departing from the spirit and principles of the techniques described herein. All modifications are intended to be included herein within the scope of this disclosure and protected by the following claims.

What is claimed is:

1. A vehicle comprising:
an antenna array for beamforming;
a navigation controller for determining a vehicle location and a travel route; and
a beamforming controller to:
identify a signal strength with a first transceiver;
search, upon the signal strength being less than a threshold, for a second transceiver based on transceiver mapping information, the vehicle location, and the travel route; and
adjust the antenna array to beamform in a predicted direction to the second transceiver.

2. The vehicle of claim 1, wherein the antenna array includes a plurality of antennas and, to adjust the antenna array, the beamforming controller adjusts a phase of at least one of the plurality of antennas of the antenna array.

3. The vehicle of claim 1, wherein, to adjust the antenna array, the beamforming controller adjusts at least one of an elevation angle and azimuth angle of a beamforming direction of the antenna array.

4. The vehicle of claim 1, further including a GPS receiver to receive the vehicle location.

5. The vehicle of claim 1, wherein the navigation controller determines the travel route based upon a driving history.

6. The vehicle of claim 1, wherein the beamforming controller determines the signal strength via a received signal strength indicator.

7. The vehicle of claim 1, wherein the beamforming controller predicts a second signal strength between the antenna array and the second transceiver based on the transceiver mapping information, the vehicle location, and the travel route.

8. The vehicle of claim 7, wherein the beamforming controller determines to adjust the antenna array to beamform in the predicted direction to the second transceiver responsive to determining that the second signal strength is greater than the threshold.

9. The vehicle of claim 1, wherein the beamforming controller adjusts a beamforming direction of the antenna array from the predicted direction in an outward spiral path about the predicted direction until the antenna array communicatively couples with the second transceiver.

10. The vehicle of claim 1, wherein the beamforming controller monitors a current signal strength upon the antenna array communicatively coupling with the second transceiver.

11. The vehicle of claim 1, further including a vehicle speed sensor to detect at least one of a vehicle speed and a vehicle acceleration, wherein the beamforming controller searches for the second transceiver further based on at least one of the vehicle speed and the vehicle acceleration.

12. The vehicle of claim 1, wherein the beamforming controller collects the transceiver mapping information that includes antenna array orientations of base transceiver stations, the base transceiver stations including the first transceiver and the second transceiver.

13. The vehicle of claim 12, wherein the beamforming controller determines the predicted direction further based on an antenna array orientation of the second transceiver.

14. The vehicle of claim 1, wherein the beamforming controller, responsive to identifying no other transceiver with an increased signal strength, adjusts the antenna array to beamform in a default direction.

15. The vehicle of claim 14, wherein the beamforming controller adjusts a beamforming direction of the antenna array from the default direction in an outward spiral path about the default direction until the antenna array communicatively couples with another transceiver.

16. A method comprising:
determining, via a navigation controller, a location and a travel route of a vehicle;
identifying, via a processor, a signal strength of a vehicle antenna array with a first transceiver;
searching, when the signal strength is less than a threshold, for a second transceiver based on transceiver mapping information, the vehicle location, and the travel route; and
adjusting the vehicle antenna array to beamform in a predicted direction to the second transceiver.

17. The method of claim 16, wherein adjusting the vehicle antenna array includes adjusting at least one of an elevation angle and azimuth angle of a beamforming direction of the vehicle antenna array.

18. The method of claim 16, further including adjusting a beamforming direction of the vehicle antenna array from the predicted direction in an outward spiral path about the predicted direction until the vehicle antenna array communicatively couples with the second transceiver.

19. The method of claim 16, further including:
adjusting the vehicle antenna array to beamform in a default direction responsive to identifying no other transceiver with an increased signal strength relative to the signal strength with the first transceiver; and
adjusting a beamforming direction of the vehicle antenna array from the default direction in an outward spiral path about the default direction until the vehicle antenna array communicatively couples with another transceiver.

20. A system comprising:
a vehicle including:
a navigation controller for determining vehicle data including a vehicle location and a travel route; and
a first antenna array to transmit the vehicle data; and
a base transceiver station including a second antenna array and configured to:
receive the vehicle data from the first antenna array;
identify a signal strength between the first antenna array and the second antenna array; and
adjust, upon determining that the signal strength is less than a threshold, the second antenna array to beamform in a predicted direction toward the vehicle based upon the vehicle data.
